(19) United States
(12) Patent Application Publication
(10) Pub. No.: US 2025/0267555 A1
(43) Pub. Date: Aug. 21, 2025

(54) COMMUNICATION CONTROL METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/198,717

(22) Filed: May 5, 2025

Related U.S. Application Data
(63) Continuation of application No. PCT/JP2023/039407, filed on Nov. 1, 2023.
(60) Provisional application No. 63/421,705, filed on Nov. 2, 2022.

(51) Int. Cl. H04W 48/08

(52) U.S. Cl. CPC H04W 48/08

(57) ABSTRACT

In an aspect, a communication control method is used in a cellular communication system. The communication control method includes broadcasting, by a parent node, migration range support information supporting a migration range of a mobile relay node. The communication control method includes receiving, by the mobile relay node, the migration range support information. The communication control method includes determining, by the mobile relay node, whether access to the parent node is available based on the migration range support information.

### RELATED APPLICATIONS

The present application is a continuation based on PCT Application No. PCT/JP2023/039407, filed on Nov. 1, 2023, which claims the benefit of U.S. Provisional Patent Application No. 63/421,705 filed on Nov. 2, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP), which is a standardization project of a cellular communication system, has studied the introduction of a new relay node referred to as an Integrated Access and Backhaul (IAB) node (for example, see Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V17.2.0 (2022-09)

### SUMMARY

In a first aspect, a communication control method is used in a cellular communication system. The communication control method includes broadcasting, by a parent node, migration range support information supporting a migration range of a mobile relay node. The communication control method includes receiving, by the mobile relay node, the migration range support information. The communication control method includes determining, by the mobile relay node, whether access to the parent node is available based on the migration range support information.

In a second aspect, a communication control method is used in a cellular communication system. The communication control method includes checking, by a mobile relay node, whether a serving cell and neighboring cells broadcast mobile relay node support information indicating that the mobile relay node is supported. The communication control method includes accessing, by the mobile relay node, a selected cell upon confirming that none of the serving cell and the neighboring cells broadcast the mobile relay node support information.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, Parent nodes, and Child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a UE (user equipment) according to the embodiment.

FIG. 6 is a diagram illustrating an example of a protocol stack related to an RRC connection and a NAS connection of an IAB-MT.

FIG. 7 is a diagram illustrating an example of a protocol stack related to an F1-U protocol.

FIG. 8 is a diagram illustrating an example of a protocol stack related to an F1-C protocol.

FIGS. 9A and 9B are diagrams illustrating an example of full migration according to a first embodiment.

FIGS. 10A and 10B are diagrams illustrating an example of full migration according to the first embodiment.

FIG. 11 is a diagram illustrating an operation example according to the first embodiment.

FIG. 12 is a diagram illustrating the operation example according to the second embodiment.

FIG. 13 is a diagram illustrating an operation example according to a third embodiment.

FIG. 14 is a diagram illustrating an operation example according to a fourth embodiment.

FIG. 15 is a flowchart illustrating an operation example according to a fifth embodiment.

FIG. 16 a diagram illustrating scenarios and subcases for UE cell reselection.

FIG. 17 a diagram illustrating a configuration of RACH-less handover using information of applicable timing advance (TA) and an uplink grant in MobilityControlInfo in LTE.

### DESCRIPTION OF EMBODIMENTS

A cellular communication system according to an embodiment will be described with reference to the drawings. In the description of the drawings, the same or similar parts are denoted by the same or similar reference signs.

### First Embodiment

### Configuration of Cellular Communication System

A configuration example of the cellular communication system according to an embodiment is described. A cellular communication system 1 according to an embodiment is a 3GPP 5G system. Specifically, a radio access scheme in the cellular communication system 1 is a New Radio (NR) being a 5G radio access scheme. Note that Long Term Evolution (LTE) may be at least partially applied to the cellular communication system 1. A future cellular communication system such as 6G may be applied to the cellular communication system 1.

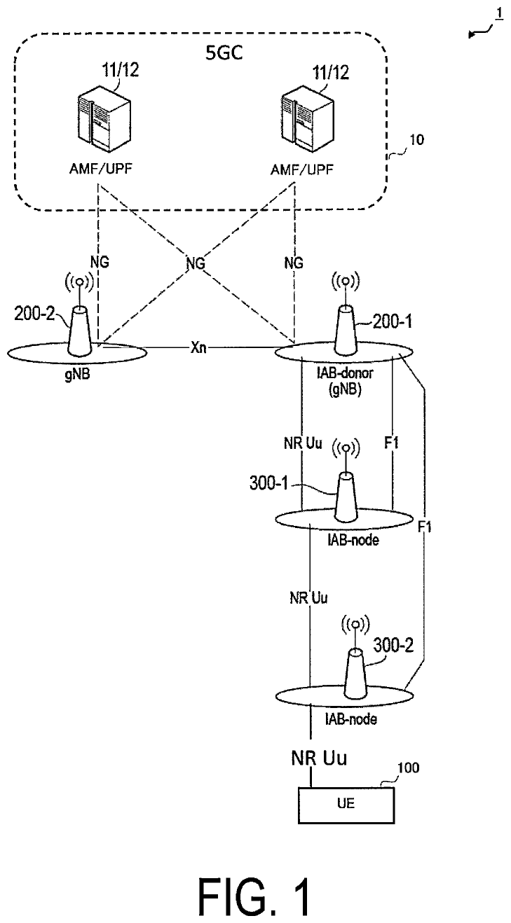

FIG. 1 is a diagram illustrating a configuration example of the cellular communication system 1 according to the embodiment.

As shown in FIG. 1, the cellular communication system 1 includes a 5G core network (5GC) 10, a User Equipment (UE) 100, base station apparatuses (hereinafter may be referred to as “base stations”) 200-1 and 200-2, and IAB nodes 300-1 and 300-2. The base station 200 may be referred to as a gNB.

In the following, an example in which the base station 200 is an NR base station will be mainly described, but the base station 200 may also be an LTE base station (that is, an eNB).

In the following, the base stations 200-1 and 200-2 may be referred to as gNBs 200 (or base station 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is an apparatus that performs various mobility controls for the UE 100. The AMF 11 communicates with the UE 100 using Non-Access Stratum (NAS) signaling to manage information on an area in which the UE 100 exists. The UPF 12 is an apparatus that performs transfer control of user data, and the like.

Each gNB 200 is a fixed radio communication node and manages one or more cells. The term “cell” is used to indicate a minimum unit of a radio communication area. The term “cell” may be used to indicate a function or resource for performing radio communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates two gNBs, that is, a gNB 200-1 and a gNB 200-2, connected to the 5GC 10.

Each gNB 200 may be divided into a Central Unit (CU) and a Distributed Unit (DU). The CU and the DU are interconnected via an interface referred to as an F1 interface. An F1 protocol is a communication protocol between the CU and the DU, and includes an F1-C protocol, which is a control plane protocol, and an F1-U protocol, which is a user plane protocol.

The cellular communication system 1 supports IAB, which enables radio relay of NR access using an NR for backhaul. The donor gNB 200-1 (or donor node; hereinafter may be referred to as “donor node”) is a terminal node of the NR backhaul on the network side, and is a donor base station having additional functions for supporting IAB. The backhaul is capable of multi-hopping via a plurality of hops (that is, a plurality of IAB nodes 300).

FIG. 1 illustrates an example in which the IAB node 300-1 is wirelessly connected to the donor node 200-1, the IAB node 300-2 is wirelessly connected to the IAB node 300-1, and the F1 protocol is transmitted by two backhaul hops.

The UE 100 is a mobile radio communication apparatus that performs radio communication with a cell. The UE 100 may be any apparatus that performs radio communication with the gNB 200 or the IAB node 300. For example, the UE 100 is a mobile phone terminal and/or a tablet terminal, a laptop PC, a sensor or an apparatus provided in a sensor, a vehicle or an apparatus provided in a vehicle, or an aircraft or an apparatus provided in an aircraft. The UE 100 is wirelessly connected to the IAB node 300 or the gNB 200 via an access link. FIG. 1 illustrates an example in which the UE 100 is wirelessly connected to the IAB node 300-2. The UE 100 indirectly communicates with the donor node 200-1 via the IAB node 300-2 and the IAB node 300-1.

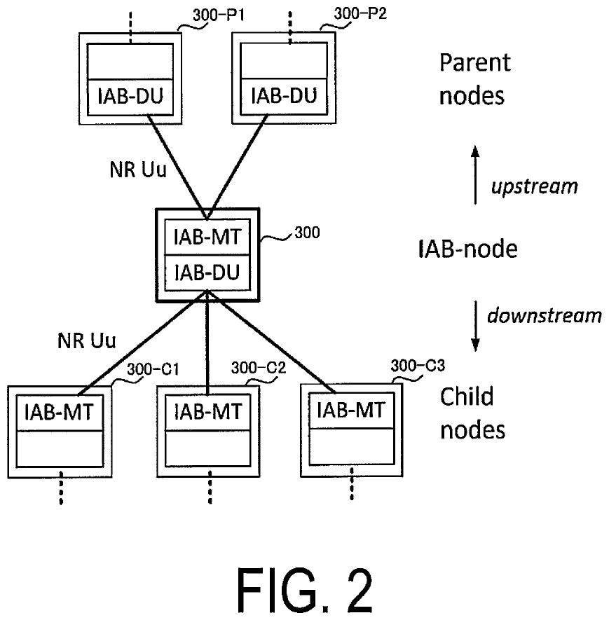

FIG. 2 is a diagram illustrating an example of a relationship between the IAB node 300, Parent nodes, and Child nodes.

As illustrated in FIG. 2, each IAB node 300 includes an IAB-DU equivalent to a base station function unit and an IAB-MT (Mobile Termination) equivalent to a user equipment function unit.

Adjacent nodes (that is, upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example in which the parent nodes of the IAB node 300 are IAB nodes 300-P1 and 300-P2. A direction toward the parent nodes is referred to as upstream. From the perspective of the UE 100, the upper node of the UE 100 may correspond to a parent node.

Adjacent nodes (that is, lower nodes) on the NR access interface of the IAB-DU are referred to as child nodes. The IAB-DU manages the cell, similar to the gNB 200. The IAB-DU terminates the NR Uu radio interface to the UE 100 and the lower IAB nodes. The IAB-DU supports the F1 protocol to the CU of the donor node 200-1. FIG. 2 illustrates an example in which the child nodes of the IAB node 300 are IAB nodes 300-C1 to 300-C3, but the child node of the IAB node 300 may also include the UE 100. A direction toward the child nodes is referred to as downstream.

All of the IAB nodes 300 connected to the donor node 200 via one or more hops form a Directed Acyclic Graph (DAG) topology (hereinafter may be referred to as “topology”) with the donor node 200 as the root. In this topology, as illustrated in FIG. 2, adjacent nodes on the IAB-DU interface are child nodes, and adjacent nodes on the IAB-MT interface are parent nodes. The donor node 200 performs central management including resource, topology, and route management of the IAB topology. The donor node 200 is a gNB that provides network access to the UE 100 via a network of backhaul links and access links.

### Configuration of Base Station

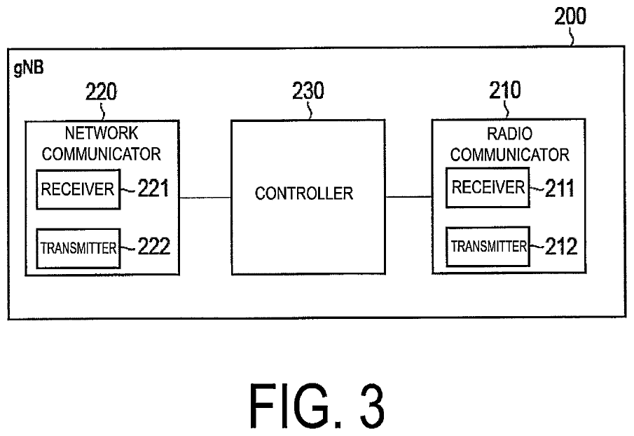

The configuration of the gNB 200, which is a base station according to the embodiment, will be described. FIG. 3 is a diagram illustrating a configuration example of the gNB 200. As illustrated in FIG. 3, the gNB 200 includes a radio communicator 210, a network communicator 220, and a controller 230.

The radio communicator 210 performs radio communication with the UE 100 and the IAB node 300. The radio communicator 210 includes a receiver 211 and a transmitter 212. The receiver 211 performs various types of reception under the control of the controller 230. The receiver 211 includes an antenna, and converts (down-converts) a radio signal received by the antenna into a baseband signal (reception signal) and outputs the signal to the controller 230. The transmitter 212 performs various types of transmission under the control of the controller 230. The transmitter 212 includes an antenna, and converts (up-converts) a baseband signal (transmission signal) output by the controller 230 into a radio signal and transmits the signal from the antenna.

The network communicator 220 performs wired communication (or radio communication) with the 5GC 10 and wired communication (or radio communication) with other adjacent gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control for the gNB 200. The controller 230 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 230 may perform all of the processing and operations in the gNB 200 in each embodiment to be described below.

### Configuration of Relay Node

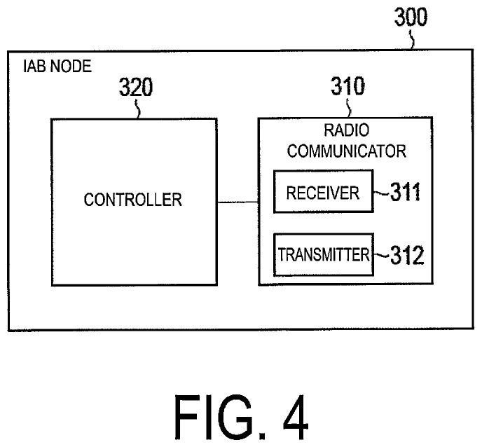

A configuration of the IAB node 300 that is a relay node (or a relay node apparatus, which may hereinafter be referred to as a “relay node”) according to the embodiment will be described. FIG. 4 is a diagram illustrating a configuration example of the IAB node 300. As illustrated in FIG. 4, the IAB node 300 includes a radio communicator 310 and a controller 320. The IAB node 300 may include a plurality of radio communicators 310.

The radio communicator 310 performs radio communication (BH link) with the gNB 200 and radio communication (access link) with the UE 100. The radio communicator 310 for BH link communication and the radio communicator 310 for access link communication may be provided separately.

The radio communicator 310 includes a receiver 311 and a transmitter 312. The receiver 311 performs various types of reception under the control of the controller 320. The receiver 311 includes an antenna, and converts (down-converts) a radio signal received by the antenna into a baseband signal (reception signal) and outputs the converted signal to the controller 320. The transmitter 312 performs various types of transmission under the control of the controller 320. The transmitter 312 includes an antenna, and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 320 may perform each process or each operation in the IAB node 300 in each embodiment to be described below.

### Configuration of User Equipment

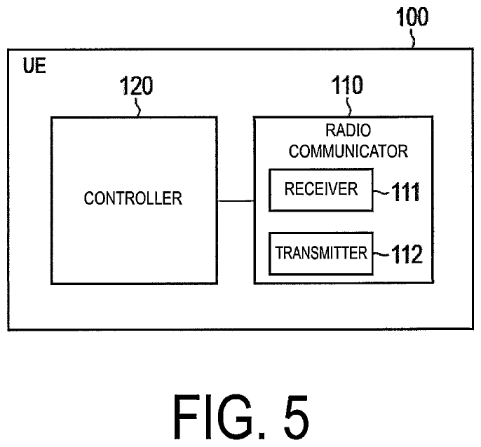

The configuration of the UE 100, which is a user equipment according to the embodiment, will be described. FIG. 5 is a diagram illustrating a configuration example of the UE 100. As illustrated in FIG. 5, the UE 100 includes a radio communicator 110 and a controller 120.

The radio communicator 110 performs radio communication in an access link, that is, radio communication with the gNB 200 and radio communication with the IAB node 300. The radio communicator 110 may also perform radio communication in a side link, that is, radio communication with other UEs 100. The radio communicator 110 includes a receiver 111 and a transmitter 112. The receiver 111 performs various types of reception under the control of the controller 120. The receiver 111 includes an antenna, and converts (down-converts) a radio signal received by the antenna into a baseband signal (reception signal) and outputs the converted signal to the controller 120. The transmitter 112 performs various types of transmission under the control of the controller 120. The transmitter 112 includes an antenna, and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The processor performs processing of layers to be described below. The controller 120 may perform each process in the UE 100 in each embodiment to be described below.

### Configuration of Protocol Stack

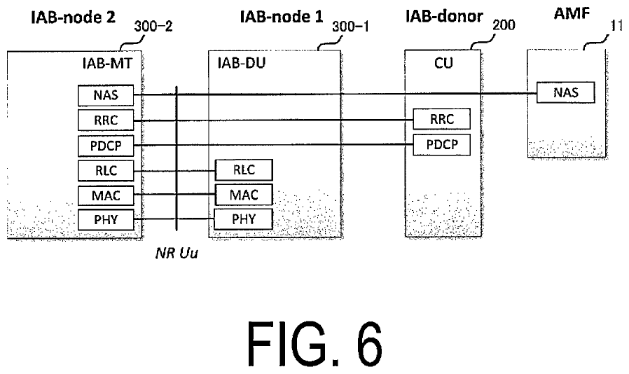

A configuration of a protocol stack according to the embodiment will be described. FIG. 6 is a diagram illustrating an example of a protocol stack related to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs coding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (transport block size, Modulation and Coding Scheme (MCS)) and assigned resource blocks for an uplink and a downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel according to establishment, re-establishment, and release of a radio bearer. RRC signaling for various configurations is transmitted between the RRC layer of the IAB-MT of the IAB node 300-2 and the RRC layer of the donor node 200. When an RRC connection with the donor node 200 is present, the IAB-MT is in an RRC connected state. When no RRC connection with the donor node 200 is present, the IAB-MT is in an RRC idle state.

The NAS layer that is positioned upper than the RRC layer performs session management, mobility management, and the like. NAS signaling is transmitted between the NAS layer of the IAB-MT of the IAB node 300-2 and the AMF 11.

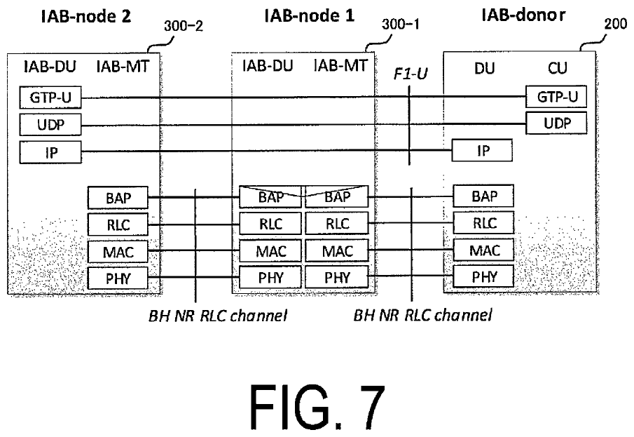

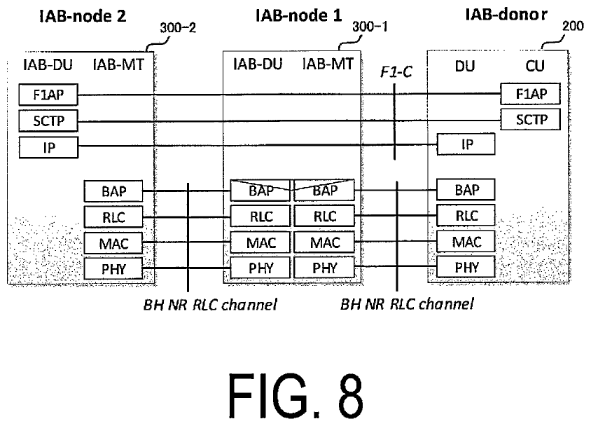

FIG. 7 is a diagram illustrating a protocol stack related to the F1-U protocol. FIG. 8 is a diagram illustrating a protocol stack related to the F1-C protocol. Here, an example in which the donor node 200 is divided into a CU and a DU is shown.

As illustrated in FIG. 7, the IAB-MT of the IAB node 300-2, the IAB-DU of the IAB node 300-1, the IAB-MT of the IAB node 300-1, and the DU of the donor node 200 each includes a Backhaul Adaptation Protocol (BAP) layer as an upper layer of the RLC layer. The BAP layer is a layer for performing a routing process and a bearer mapping/demapping process. In the backhaul, the IP layer is transmitted via the BAP layer, which allows routing by a plurality of hops.

In each backhaul link, a Protocol Data Unit (PDU) of the BAP layer is transmitted by a backhaul RLC channel (BH NR RLC channel). A plurality of backhaul RLC channels are configured in each BH link, thus enabling traffic prioritization and Quality of Service (QOS) control. The PDU of the BAP is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and an UDP layer illustrated in FIG. 7.

In the following, processes or operations performed in the IAB-DU and IAB-MT of the IAB may be simply described as processes or operations of the “IAB”. For example, the transmission of a message of the BAP layer to the IAB-MT of the IAB node 300-2 by the IAB-DU of the IAB node 300-1 will be described as the transmission of the message to the IAB node 300-2 by the IAB node 300-1. Processes or operations of the DU or CU of the donor node 200 may also be described simply as processes or operations of the “donor node”.

An upstream direction and an uplink (UL) direction may be used without distinction. A downstream direction and a downlink (DL) direction may be used without distinction.

### Mobile IAB Node

At present, 3GPP has started to study the introduction of a mobile IAB node. The mobile IAB node is, for example, a mobile IAB node. The mobile IAB node may be a movable IAB node. The mobile IAB node may be an IAB node that is capable of moving. The mobile IAB node may be an IAB node that is currently stationary but is certain to move in the future (or is expected to move in the future).

The mobile IAB node allows, for example, the UE 100 under the control of the mobile IAB node to receive services from the mobile IAB node while moving in accordance with the movement of the mobile IAB node. For example, a case is assumed in which a user (or UE 100) who is getting on a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be an IAB node that is stationary. The intermediate IAB node may be a stationary IAB node. The intermediate IAB node may be an IAB node that is stationary (or does not move) in a state of being installed at its installation location. The intermediate IAB node may be a stationary IAB node that does not move. The intermediate IAB node may be a fixed IAB node.

The mobile IAB node can also be connected to the intermediate IAB node. The mobile IAB node can also be connected to the donor node 200. The mobile IAB node can also change its connection destination due to its movement (migration or handover). A connection source may be the intermediate IAB node. The connection source may be the donor node 200. The connection destination may be the intermediate IAB node. The connection destination may be the donor node 200.

In the following, the migration of the mobile IAB node and the handover of the mobile IAB node may be used without distinction.

In the following, a mobile IAB node may be a “mobile IAB node”. The mobile IAB node may be a “migrating IAB node”. In either case, the node may be referred to as a mobile IAB node.

### Full Migration of Mobile IAB Node

The mobile IAB node may move between the donor nodes (IAB-donors) 200.

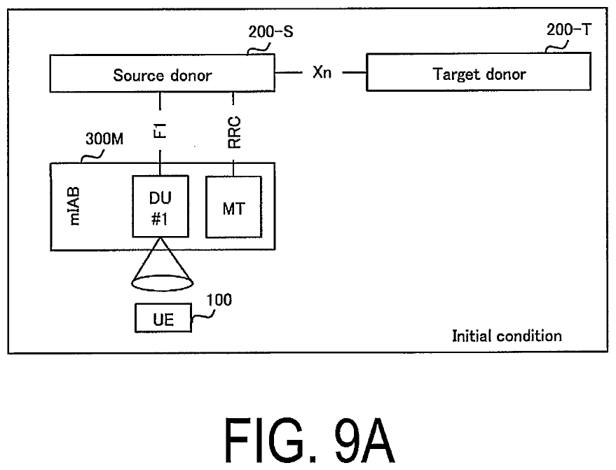

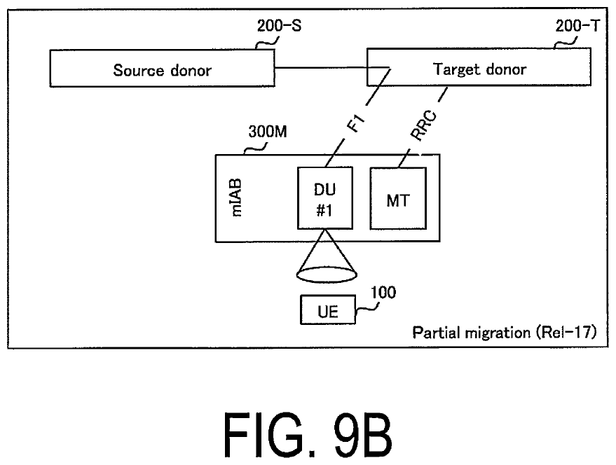

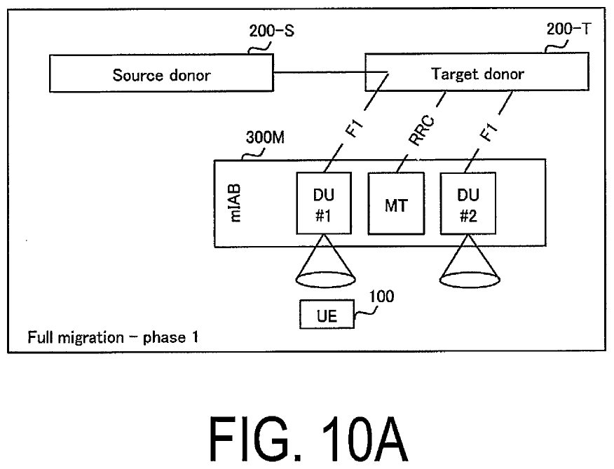

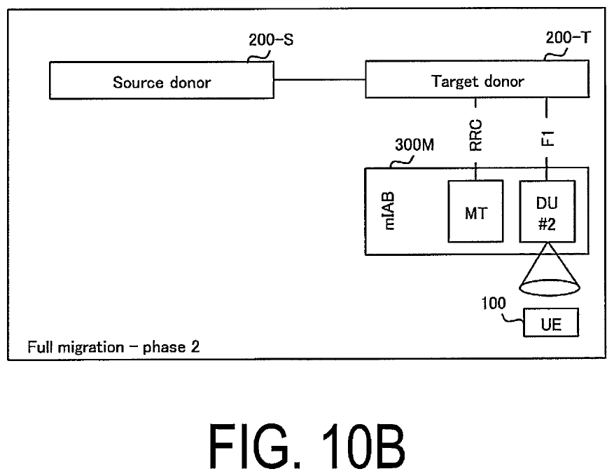

FIGS. 9A to 10B are diagrams illustrating an example of a procedure when a mobile IAB node 300M moves from a source donor node 200-S to a target donor node 200-T. The mobile IAB node 300M accommodates the UE 100 under its control. FIG. 9A illustrates an example in which the UE 100 exists in a cell range formed by an IAB-DU#1 of the mobile IAB node 300M. The UE 100 can move together with the mobile IAB node 300M.

FIG. 9A illustrates an example of an Initial condition. The IAB-DU#1 of the mobile IAB node 300M has established an F1 connection with the CU of the source donor node 200-S. The IAB-MT of the mobile IAB node 300M has also established an RRC connection with the CU of the source donor node 200-S.

FIG. 9B illustrates an example of a case where the mobile IAB node 300M has moved to the target donor node 200-T, resulting in a state of Partial migration with respect to the target donor node 200-T. As illustrated in FIG. 9B, in the partial migration, the IAB-DU#1 (and UE 100) of the mobile IAB node 300M is terminated in the CU of the source donor node 200-S, while the IAB-MT of the mobile IAB node 300M has moved to the CU of the target donor node 200-T. The IAB-MT of the mobile IAB node 300M has established an RRC connection with the CU of the target donor node 200-T. The IAB-DU of the mobile IAB node 300M has established an F1 connection with the source donor node 200-S. The partial migration refers to, for example, a state in which the connection of the UE 100 under the control of the mobile IAB node 300M remains in the source donor node 200-S via the IAB-DU#1 of the mobile IAB node 300M.

FIG. 10A illustrates an example of a case where the mobile IAB node 300M subsequently enters a state of a phase 1 of Full migration with respect to the target donor node 200-T. In the phase 1 of the full migration, the UE 100 remains connected to the source donor node 200-S via the IAB-DU#1, but a new IAB-DU#2 has established an F1 connection with the CU of the target donor node 200-T. Here, the IAB-DU#1 and the IAB-DU#2 may be logical IAB-DUs. One physical IAB-DU may include two logical IAB-DUs (IAB-DU#1 and IAB-DU#2).

FIG. 10B illustrates an example of a case where the mobile IAB node 300M subsequently enters a state of a phase 2 of full migration with respect to the target donor node 200-T. In the phase 2 of the full migration, the connection of the mobile IAB node 300M (and UE 100) has moved from the CU of the source donor node 200-S to the CU of the target donor node 200-T. The full migration refers to, for example, a state in which the connection of the UE 100 has moved to the target donor node 200-T via the IAB-DU#2 of the mobile IAB node 300M.

In addition, movement between CUs using two DUs (IAB-DU#1 and IAB-DU#2) by the mobile IAB node 300M may be referred to as “dual DU approach”. For example, the dual DU approach is performed when the UE 100 moves from one CU and DU to the other CU and DU.

### Communication Control Method According to First Embodiment

The 3GPP discusses mobile IAB node support information (“supporting mobile-IAB”) indicating that the mobile IAB node 300M is supported. The mobile IAB node support information is broadcast from a cell, for example. Upon receiving the mobile IAB node support information is received, the mobile IAB node 300M can recognize that the mobile IAB node 300M can access (camp on or connect to) the cell. The mobile IAB node support information is, for example, 1-bit information.

Meanwhile, a migration method for the IAB node 300 is as follows.
(1) Intra-CU migration (Rel-16: Intra-CU topology adaptation)
(2) Partial migration (Rel-17: Inter-CU topology adaptation/partial migration)
(3) Full migration (Rel-18: Inter-CU topology adaptation/full migration)

Depending on the migration range in which the mobile IAB node 300M migrates, the donor node 200 (or parent node 300P) accessed by the mobile IAB node 300M may change.

For example, when restricted to migration within the same CU, the mobile IAB node 300M can access the donor node 200 compliant with Rel-16 and can also access the donor node 200 compliant with Rel-17 and Rel-18. On the other hand, when migrating between different CUs, the mobile IAB node 300M need to access the donor node 200 compliant with Rel-17 and Rel-18, and accessing the donor node 200 compliant with Rel-16 prevents the mobile IAB node 300M from migrating between the CUS.

In this situation, the donor node 200 is assumed to broadcast the mobile IAB node support information. The mobile IAB node support information only indicates that the donor node 200 having broadcast the information can support access to the mobile IAB node 300M. Upon receiving the mobile IAB node support information, the mobile IAB node 300M does not know which release the donor node 200 having broadcast the information corresponds to. On the other hand, it is conceivable that, for example, the mobile IAB node 300M may be uniformly permitted to access the donor node 200 compliant with Rel-17 or Rel-18 instead of the donor node 200 compliant with Rel-16. However, in this case, the mobile IAB node 300M cannot access the donor node 200 compliant with Rel-16. Therefore, the coverage area of the donor node 200 may not be effectively utilized.

As described above, the migration of the mobile IAB node 300M cannot be completely covered only by the mobile IAB node support information. Accordingly, the network side may not be able to provide appropriate access to the mobile IAB node 300M.

Thus, an object of the first embodiment is to enable the mobile IAB node 300M to appropriately access other nodes.

Accordingly, in the first embodiment, an example will be described in which the parent node 300P (or the donor node 200) broadcasts support information for supporting the migration range of the mobile IAB node 300M, and the mobile IAB node 300M determines whether to allow access to the parent node 300P (or the donor node 200) based on the support information.

To be more specific, first, a parent node (e.g., the parent node 300P or the donor node 200) broadcasts migration range support information for supporting the migration range of a mobile relay node (e.g., the mobile IAB node 300M). Second, the mobile relay node receives the migration range support information. Third, the mobile relay node determines whether access the parent node is available based on the migration range support information.

As a result, for example, the mobile IAB node 300M can access the parent node 300P according to the migration range of the mobile IAB node 300M, and thus the mobile IAB node 300M can appropriately access the parent node 300P.

Note that the following description may take the parent node 300P as an example of the access destination of the mobile IAB node 300M. The access destination of the mobile IAB node 300M may be the donor node 200. Alternatively, the access destination of the mobile IAB node 300M may be another node.

In the following description, the meaning of “access” may include “camp”. “Camp” refers to, for example, a state in which the IAB-MT of the mobile IAB node 300M in an RRC idle state or an RRC inactive state has completed a cell selection procedure or a cell reselection procedure to select a cell used to monitor system information or paging information. In the description, the meaning of “access” may include “connection”. “Connection” refers to, for example, a state in which the IAB-MT of the mobile IAB node 300M is in an RRC connected state for the cell and can exchange RRC messages with the cell. “Access” may be at least one of “camp” or “connection”.

### Operation Example According to First Embodiment

An operation example according to the first embodiment will be described.

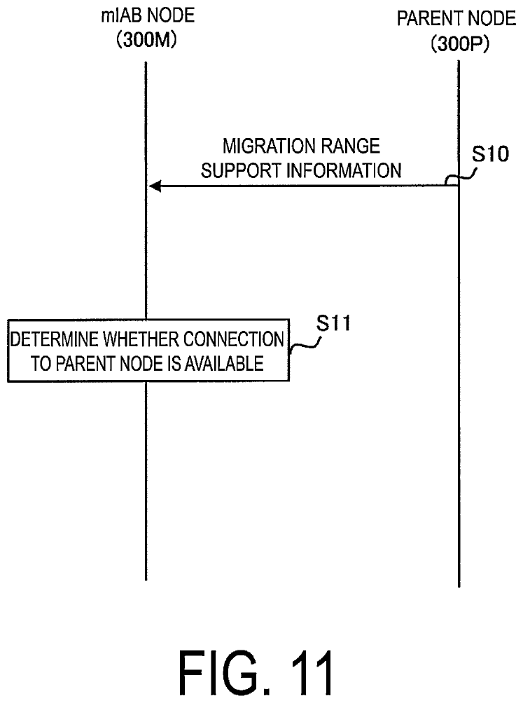

FIG. 11 is a diagram illustrating an operation example according to the first embodiment.

As illustrated in FIG. 11, in step S10, the parent node 300P broadcasts the migration range support information. The migration range support information indicates, for example, a migration range that can be supported by a node (or a cell) having broadcast the information. The parent node 300P broadcasts the migration range support information by using broadcast signaling (e.g., system information blocks (SIBs)). The parent node 300P may transmit the migration range support information to the UE 100 by using individual signaling (for example, an RRC message). Examples of information included in the migration range support information include the following.

First, the migration range support information may include information indicating a topology adaptation function that can be supported in the parent node 300P. Specifically, the information may be any one of “Rel-16: Intra-CU topology adaptation”, “Rel-17: Inter-CU topology adaptation/partial migration”, and “Rel-18: Inter-CU topology adaptation/full migration”. Alternatively, the information may be any one of “Rel-16”, “Rel-17”, and “Rel-18”. The information representing the topology adaptation capability may represent, for example, a migration method for the mobile IAB node 300M. The migration method of the mobile IAB node 300M may be, for example, any one of “intra-CU migration”, “partial migration”, and “full migration”.

Second, the migration range support information may include information related to the migration range of the mobile IAB node 300M that can be supported in the parent node 300P. Specifically, the information may be any one of “short distance”, “intermediate distance”, and “long distance”. “Short distance” represents, for example, correspondence to “intra-CU migration”. “Intermediate distance” indicates, for example, corresponding to “partial migration” between different CUs. “Long distance” indicates, for example, correspondence to “full migration” between different CUs. The division of the information may be other than three divisions, and may be two divisions or four or more divisions. For example, in the case of two divisions, the divisions include the “short distance” and the “long distance”, and the “short distance” may represent the “intra-CU migration” and the “long distance” may represent the “partial migration” and the “full migration”.

In step S11, the mobile IAB node 300M receives the migration range support information broadcast from the parent node 300P, and determines whether access to the parent node 300P is available based on the migration range support information. In particular, the mobile IAB node 300M may compare the migration range of the mobile IAB node 300M with the migration range support information and determine that access to the parent node 300P is available when the parent node 300P corresponds to the migration range of the mobile IAB node 300M. On the other hand, the mobile IAB node 300M may determine that access to the parent node is not available when the parent node 300P does not correspond to the migration range of the mobile IAB node 300M.

### Second Embodiment

A second embodiment will be described. In the second embodiment, differences from the first embodiment will mainly be described.

In the first embodiment, an example has been described in which, upon receiving the migration range support information, the mobile IAB node 300M compares the migration range of the mobile IAB node 300M with the migration range support information. Here, a problem with this example is how to configure the migration range of the mobile IAB node 300M. In the second embodiment, a method of configuring the migration range of the mobile IAB node 300M will be described.

To be more specific, the mobile relay node (for example, the mobile IAB node 300M) receives the migration range information related to the migration range of the mobile relay node from an operations, administration and management apparatus (for example, an OAM server 400) or an access mobility management apparatus (for example, AMF 11). As a result, for example, the mobile IAB node 300M can recognize the migration range of the mobile IAB node 300M.

### Operation Example According to Second Embodiment

An operation example according to the second embodiment will be described. In the operation example according to the second embodiment, there are two operation examples, i.e., an operation example (first operation example) in which the mobile IAB node 300M receives configuration from the Operations, administration and management (OAM) server 400 and an operation example (second operation example) in which the mobile IAB node 300M receives configuration from the AMF 11.

### First Operation Example

First, an example in which the mobile IAB node 300M is configured by the OAM server 400 will be described.

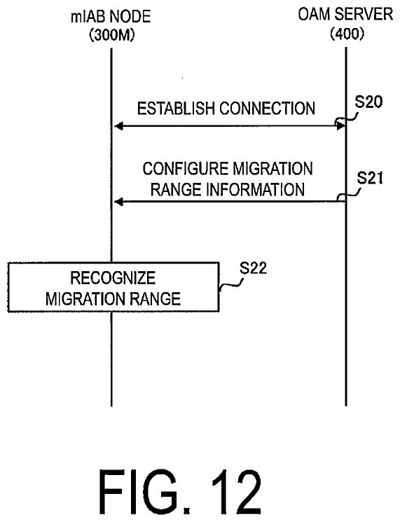

FIG. 12 is a diagram illustrating a first operation example according to the second embodiment.

As illustrated in FIG. 12, the mobile IAB node 300M connects to the OAM server 400 in step S20. The mobile IAB node 300M may connect to the OAM server 400 by transmitting a predetermined Internet Protocol (IP) message to the OAM server 400.

In step S21, the OAM server 400 configures a migration range for the mobile IAB node 300M. The OAM server 400 may configure the migration range by transmitting, to the mobile IAB node 300M, the migration range information related to the migration range. The OAM server may transmit the migration range information to the mobile IAB node 300M by utilizing an IP message. The migration range information is, for example, as follows.

First, the migration range information may include a migration distance pattern. Specifically, the migration distance pattern may be any one of “short distance”, “intermediate distance”, and “long distance”. The division of the migration distance pattern may correspond to the division of the information related to the migration range included in the migration range support information (any one of “short distance”, “intermediate distance”, and “long distance”). The number of divisions of the migration distance pattern may be two or four or more.

Second, the migration range information may include information indicating whether the node is a mobile IAB node. Specifically, the information may be “Mobile IAB-node” (indicating a mobile IAB node) or “Stationary IAB-node” (indicating a stationary (or intermediate) IAB node). “Mobile IAB-node” may represent correspondence to “intermediate distance” or “long distance” as the distance pattern. “Stationary IAB-node” may represent correspondence to “short distance” (or “intermediate distance”) as the distance pattern.

Third, the migration range information may include a release version. Specifically, the release version may be any one of “Rel-16”, “Rel-17”, and “Rel-18”. “Rel-16” may represent configuration as a stationary (or intermediate) IAB node. “Rel-17” and “Rel-18” may represent configuration as a mobile IAB node.

In step S22, the mobile IAB node 300M receives the configuration of the migration range from the OAM server 400, and recognizes the migration range of the mobile IAB node 300M based on the migration range information.

### Second Operation Example

A second operation example will be described.

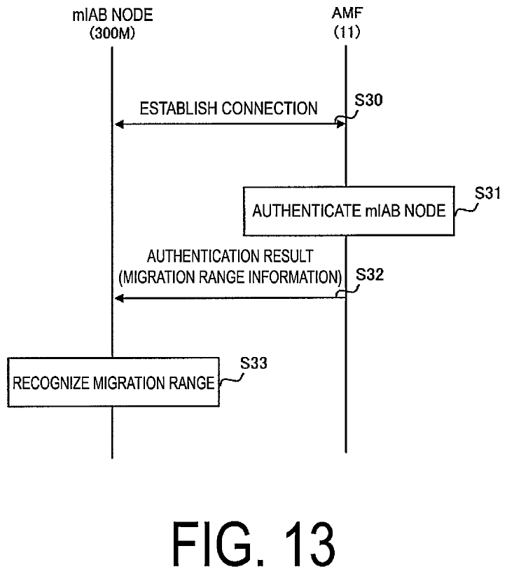

FIG. 13 is a diagram illustrating the second operation example according to the second embodiment.

As illustrated in FIG. 13, in step S30, the mobile IAB node 300M has established a connection to the AMF 11. The IAM-MT of the mobile IAB node 300M may establish a connection to the AMF 11 by transmitting a registration request (REGISTRATION REQUEST) message to the AMF 11.

In step S31, the AMF 11 performs authentication processing on the mobile IAB node 300M. The AMF 11 may cause an authentication server (Authentication Server Function (AUSF)) to perform authentication processing on the mobile IAB node 300M.

In step S32, the AMF 11 transmits an authentication result to the IAM-MT of the mobile IAB node 300M. The AMF 11 transmits the authentication result to the mobile IAB node 300M by utilizing a NAS message.

First, the authentication result may be indicated by whether the mobile IAB node 300M has been authenticated. Alternatively, the authentication result may be indicated by whether the mobile IAB node 300M has been authenticated by using any of the migration distance patterns (for example, a long distance is authenticated, or the like).

Second, the AMF 11 may configure the migration range of the mobile IAB node 300M based on the authentication result. The AMF 11 may configure the migration range by transmitting, to the IAB-MT of the mobile IAB node 300M, a NAS message including the migration range information. The migration range information may be the same as the migration range information configured by the OAM server 400.

In step S33, the mobile IAB node 300M may recognize the (permitted) migration range based on the authentication result. Alternatively, the mobile IAB node 300M may recognize the migration range based on the migration range information set by the AMF 11.

### Third Embodiment

A third embodiment will be described.

In the second embodiment, an example has been described in which the migration range is configured for the mobile IAB node 300M. In the third embodiment, description will be given of what processing is performed when the mobile IAB node 300M with the migration range configured therefor receives the mobile IAB node support information from the parent node 300P.

To be more specific, first, the mobile relay node (for example, the mobile IAB node 300M) determines whether the parent node (for example, the parent node 300P) broadcasts mobile relay node support information indicating that the mobile relay node is supported. Second, the mobile relay node determines whether access to the parent node is available based on the migration range information and whether the mobile relay node support information is broadcast.

As described above, the mobile IAB node 300M determines whether access to the parent node 300P is available by using not only the mobile relay node support information but also the migration range configured for the mobile IAB node 300M. Accordingly, the mobile IAB node 300M can appropriately access the parent node 300P as compared with the case where whether access is available is determined based only on the mobile relay node support information.

### Operation Example According to Third Embodiment

An operation example according to the third embodiment will be described.

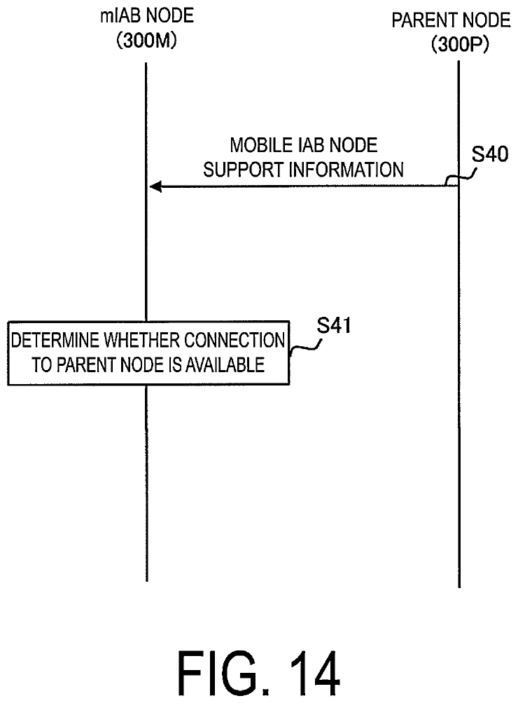

FIG. 14 is a diagram illustrating an operation example according to the third embodiment. Note that a migration range is assumed to be configured for the mobile IAB node 300M (second embodiment) before the operation example illustrated in FIG. 14 is started.

As illustrated in FIG. 14, in step S40, the parent node 300P broadcasts or does not broadcast the mobile IAB Node support information.

In step S41, the mobile IAB node 300M determines whether the parent node 300P broadcasts the mobile IAB node support information. Then, the mobile IAB node 300M determines whether access to the parent node 300P is available based on whether the mobile IAB node support information is broadcast (or whether the information is received) and the migration range configured for the mobile IAB node 300M. The mobile IAB node 300M makes the determination as follows, for example.

First, when the parent node 300P does not broadcast the mobile IAB node support information, and “short distance” (or stationary (intermediate) IAB node) is configured for the mobile IAB node 300M as the migration range, the mobile IAB node 300M determines that the mobile IAB node 300M can access the parent node 300P.

Second, when the parent node 300P does not broadcast the mobile IAB node support information, and “long distance” (or mobile IAB node) is configured for the mobile IAB node 300M as the migration range, the mobile IAB node 300M determines that the mobile IAB node 300M cannot access the parent node 300P.

Third, when the parent node 300P broadcasts the mobile IAB node support information, the mobile IAB node 300M determines that the mobile IAB node 300M can access the parent node 300P regardless of “short distance” or “long distance”.

As described above, in the third embodiment, even when the parent node 300P does not broadcast the mobile IAB node support information, the mobile IAB node 300M with “short distance” (or stationary (intermediate) IAB node) configured therefor can access the parent node (for example, the Rel-16-compliant donor node 200). Therefore, as compared with the case where the mobile IAB node 300M is uniformly allowed to access the donor node 200 compliant with Rel-18, the third embodiment also permits access to the donor node 200 compliant with Rel-16, and thus loads can be distributed or coverage can be expanded, throughout the network.

### Fourth Embodiment

A fourth embodiment will be described.

The mobile IAB node 300M is assumed to be located in a network (or topology) subordinate to the donor node 200 compliant with Rel-16 and cannot discover a cell used to broadcast the mobile IAB node support information. In this case, the mobile IAB node 300M may determine that no cell supports the mobile IAB node and may not be able to access the network.

Therefore, in the fourth embodiment, an example will be described in which the mobile IAB node 300M is permitted to access a cell used to broadcast the mobile IAB node support information even when the mobile IAB node 300M cannot discover the cell.

Specifically, first, the mobile relay node determines whether the serving cell and the neighboring cells broadcast the mobile relay node support information indicating that the mobile relay node is supported. Second, upon detecting that none of the serving cell and the neighboring cells broadcast the mobile relay node support information, the mobile relay node accesses the selected cell.

As a result, the mobile IAB node 300M can appropriately access a cell used to broadcast the mobile IAB node support information even when the mobile IAB node 300M has failed to discover the cell.

### Operation Example According to Fourth Embodiment

An operation example according to the fourth embodiment will be described.

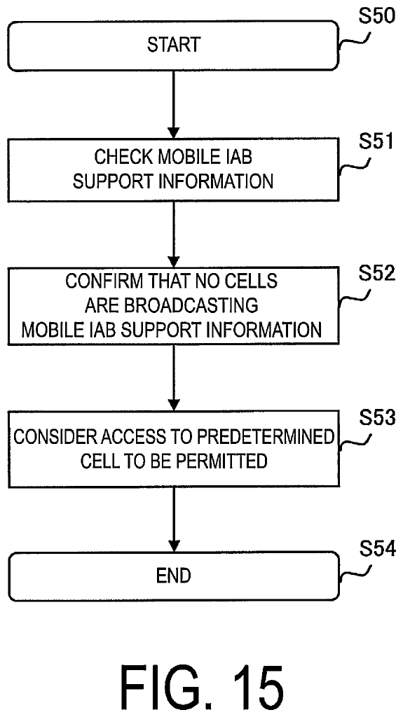

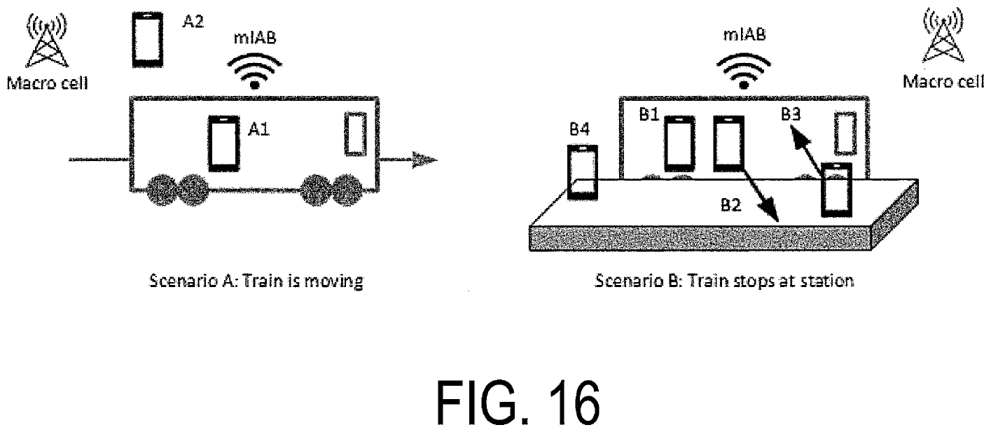

With reference to FIG. 15, the operation example according to the fourth embodiment will be described.

As illustrated in FIG. 15, in step S50, the mobile IAB node 300M starts the processing.

In step S51, the IAB-MT of the mobile IAB node 300M monitors the serving cell and all of the neighboring cells and checks whether the mobile IAB node support information is broadcast.

In step S52, the IAB-MT of the mobile IAB node 300M confirms that the mobile IAB node support information is broadcast in none of the cells.

In step S53, the mobile IAB node 300M assumes that access to the predetermined cell is permitted. When, in none of the cells, the mobile IAB node support information is broadcast from the donor node 200, the AMF 11, or the OAM server 400 to the mobile IAB node 300M, permitting access to a predetermined cell may be configured in advance. For example, the configuration may be performed by the CU of the donor node 200, the AMF 11, or the OAM server 400 transmitting, to the IAB-MT of the mobile IAB node 300M, an RRC message, an NAS message, or an IP message including information indicating the configuration. The predetermined cell may be a cell having the best radio quality.

Then, the mobile IAB node 300M starts accessing the cell selected as the predetermined cell.

In step S54, the mobile IAB node 300M terminates a series of processing operations.

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

Although the term “network node” mainly refers to a base station, it may also refer to an apparatus of a core network or a part (CU, DU or RU) of a base station. The network node may include a combination of at least a part of the apparatus of the core network and at least a part of the base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The embodiments, the operation examples, or the different types of processing may be combined as appropriate as long as they are not inconsistent with each other.

### FIRST SUPPLEMENTARY NOTES

### Supplementary Note 1

A communication control method used in a cellular communication system, the communication control method including the steps of:
broadcasting, by a parent node, migration range support information supporting a migration range of a mobile relay node;
receiving, by the mobile relay node, the migration range support information; and
determining, by the mobile relay node, whether access to the parent node is available based on the migration range support information.

### Supplementary Note 2

The communication control method according to Supplementary Note 1, in which
the migration range support information represents either a migration method for the mobile relay node that is supportable by the parent node or a migration range of the mobile relay node that is supportable by the parent node.

### Supplementary Note 3

The communication control method according to Supplementary Note 1 or Supplementary Note 2, in which
the migration method for the mobile relay node is one of intra-CU migration, partial migration, and full migration.

### Supplementary Note 4

The communication control method according to any one of Supplementary notes 1 to 3, further including
receiving, by the mobile relay node, migration range information regarding the migration range of the mobile relay node from an operations, administration and management apparatus (OAM) or an access mobility management apparatus (AMF).

### Supplementary Note 5

The communication control method according to any one of Supplementary Notes 1 to 4, further including
determining, by the mobile relay node, whether the parent node broadcasts mobile relay node support information indicating that the mobile relay node is supported, in which
the determining whether access to the parent node is available includes determining, by the mobile relay node, whether access to the parent node is available based on whether the mobile relay node support information is broadcast and the migration range information.

### Supplementary Note 6

A communication control method used in a cellular communication system, the communication control method including the steps of:
checking, by a mobile relay node, whether a serving cell and neighboring cells broadcast mobile relay node support information indicating that the mobile relay node is supported; and
accessing, by the mobile relay node, a selected cell upon confirming that none of the serving cell and the neighboring cells broadcast the mobile relay node support information.

### SECOND SUPPLEMENTARY NOTES

### Introduction

The WID related to a mobile IAB was revised in the RAN#97e with the following objectives. The detailed objectives of WI are as follows.
A mobility/topology adaptation procedure for realizing mobility of an IAB node is defined, including inter-donor migration (full migration) of the entire mobile IAB node.
The mobile IAB node can connect to a fixed (intermediate) IAB node. No priority is given to optimization specific to a scenario where the mobile IAB node is connected to the stationary (intermediate) IAB node or is directly connected to an IAB donor DU.
Mobility of a dual-connected IAB node is deprioritized.
The mobility of the IAB node and a UE receiving a service of the IAB node is enhanced, including aspects related to group mobility. There is no optimization related to targeting of neighboring UEs.

Note: Solutions should avoid touching on topics already discussed in the Rel-17 or topics excluded from the Rel-17, except for IAB node mobility-specific enhancements.
Mitigation of interference due to IAB node mobility, including avoidance of a potential collision between reference signal and control signal (PCI, RACH, and the like).

The following principles should be respected:
The mobile IAB node should be able to provide a service to a legacy UE.
There is a possibility that solutions providing optimization for the mobile IAB may involve enhancements to the Rel-18 UE.

One of main problems in the Rel-18 is how to efficiently execute handovers of a plurality of descendant UEs during movement between mobile IAB nodes. In these appendices, details of mobility enhancement for a mobile IAB are described.

### Discussion

### Enhanced UE Mobility

### Handover Procedure of UE

The RAN2#119bis-e has reached the following agreement in regard to a handover procedure of the UE.

The RAN2 focuses on a scenario in which during full migration, the UE recognizes two logical DU cells as different physical cells (for example, the same carriers have different PCIs) and the two logical DU cells use separate physical resources (that is, time-frequency resources in which different carriers or the same carriers are orthogonal to one another as supported in legacy L1). From QC tdoc, the following options O1, O2, and O3 are taken into account.
1) Suspension of a message by the logical source IAB-DU
2) Conditional execution by the UE (including a CHO with a new trigger) based on broadcast indication, for example, SIB indication of a service time or DCI indication of MT migration
3) Legacy CHO (including implementation specific operations such as the use of source cell power down and target cell power up for triggering an actual HO)

The RAN2 assumes that 01 and 03 described above are functional, and further studies are needed when 02 described above (the new trigger and the like) is required.

O1, involving the suspended delivery, operates with Rel-15 UEs and is thus considered as a baseline. O3 with the current conditional handover (CHO) operates with Rel-16 UEs. Therefore, whether to enhance the CHO for the Rel-18, such as by basing the CHO on O3, requires further studies.

There are already viable solutions, such as O1 and O3, and thus whether enhancement is really needed is questionable. On the other hand, Rel-18 UEs are assumed to occupy the majority of the network at some point in the future. In this case, if the existing solutions have any disadvantages, providing some enhancements for the Rel-18 and beyond UEs is useful. When a new solution is discussed, one of the important points is to prevent the UE handover from generating a signaling storm, as pointed out in the RAN2#119bis-e.
Proposal 1: The RAN2 should discuss whether there is a problem with the existing solutions for the UE handover, i.e., the suspended delivery (O1) and the CHO (O3).

In case of O1, the RRC reconfiguration with synchronization is suspended by the mobile IAB node and delivered to the UE when the mobile IAB-MT has completed migration to the target donor. The mobile IAB node can manage the transmission timing of the RRC reconfiguration message, and thus the reception timing of the RRC reconfiguration complete message can be controlled. This depends on the amount of time during which the two cells (in other words, the cells are provided by the dual DU) are maintained, but during the period, a portion of DL loads may occur in the source cell and a portion of UL loads may occur in the target cell.

In case of O3, the RRC reconfiguration including the conditional reconfiguration is transmitted in advance by the IAB donor through the mobile IAB node. This enables advance preparation of the UE handover command, allowing the DL loads to be distributed in time in the source cell. On the other hand, the CHO is executed when an existing event (i.e., A3/A5) is satisfied. O3 depends on the radio condition of the source/target cell (i.e. control of transmit power), and thus, the target cell may cause a UL signaling storm, i.e. PRACH and RRC reconfiguration completion, especially when the source and target cells are provided by physically quasi-common antennas.

Based on the above-described observation, O1 may need to maintain the source cell and the target cell for a long time to reduce the DL/UL loads. O3 may cause a UL signaling storm in the target cell. In other words, the signaling storm can be avoided by maintaining the two cells (provided by the dual DU) for a minimum period of time.
Proposal 2: When the CHO is enhanced for Rel-18 UEs, the RAN2 should agree on a solution that avoids a signaling storm in the DL (source cell) and UL (target cell) even when the source and target cells are held for the minimum period of time during the migration of the mobile IAB node.

### Enhancement of Cell Reselection Function of UE

The RAN2#119bis-e has agreed on the following confirmations, observations, and assumptions.

The RAN2 has confirmed that the mobile IAB needs to coordinate with legacy UEs.

The RAN2 has confirmed that when camping on/connecting to a mobile IAB cell for an extended period of time, the UE may consider itself to be on board the mobile IAB cell (in other words, the UE needs to know that the cell is such a cell). The time needs to be further studied. The RAN2 makes the following assumptions for the UE operating in the mobile IAB cell.
Assumption 1: From a viewpoint of the NW for the mobile IAB cell, no change is made to the configuration principle of legacy parameters (including cell (re) selection, cell reservation and access restriction) for the legacy IAB cell.
Assumption 2: There is no specification impact on the operations of legacy UEs.
Assumption 3: The information of the mobile IAB cell newly broadcast by the R18 (if agreed) does not prohibit/control access from legacy UEs.
Assumption 4: Non-enhancement-capable UEs (including legacy UEs and non-enhancement-capable R18 UEs) only ignore the information of the mobile IAB cell newly broadcast by the R18 (if agreed).
RAN2 assumption: The broadcast information of the mobile IAB cell

To assist mobility in an idle/inactive mode of the Rel-18 UE, a 1-bit mobile IAB cell type indication is introduced (further studies are needed when the UE needs to know that the UE is on board the mobile IAB cell).

How the indication is to be used needs to be further studied (this may vary depending on the implementation).

From a viewpoint of mobile IAB WI, the RAN2 has specified no modifications for preventing surrounding UEs from accessing the mobile IAB node. However, the RAN2 considers that the SA2 may be working on applicable Rel-18 solutions.

Two main scenarios and certain subcases involving expected operations of the UE can be considered as follows.
Scenario A: The mobile IAB node is migrating together with a camped UE.
Subcase A1: The UE (on a train or the like) needs to stay on the mobile IAB node.
Subcase A2: Surrounding UEs (outside the train or the like) should not camp on the mobile IAB node.
Scenario B: The mobile IAB node is at a stop together with the camped UE.
Subcase B1: The UE (for example, still on the train) should stay on the mobile IAB node.
Subcase B2: The UE (for example, getting off the train) reselects a stationary cell (for example, a macro cell).
Subcase B3: The surrounding UEs (for example, getting on the train) need to reselect the mobile IAB node.
Subcase B4: The surrounding UEs (for example, still at the station) should stay on the fixed cell.

In a subcase A1, UE moves together with a mobile IAB node. For this reason, RSRP and RSRQ from the mobile IAB node are always stable and sufficiently good. This does not trigger a cell reselection procedure. To be exact, when the frequency priority of the mobile IAB node is higher than that of the external cells, the UE may not perform intra-frequency or inter-frequency measurements. For example, the mobile IAB node broadcasts the frequency priority of the mobile IAB node as “7” or broadcasts the cell of the mobile IAB node as an HSDN cell.

The train includes a plurality of vehicles and the mobile IAB node may be deployed in each vehicle. Even when the UE moves between the vehicles, one of the mobile IAB node cells is always more stable than the external macro cell from a perspective of the UE in the train. As a typical case, the mobile IAB node cells are assumed to operate on the same frequency. In this case, the existing intra-frequency cell reselection, that is, R-criterion, functions appropriately.
Observation 1: In a typical configuration, the migrating mobile IAB cell may broadcast a serving frequency priority of “7” or an HSDN cell indication in such a manner that the UE migrating with the mobile IAB cell does not undergo cell reselection.

In the subcases B1 and B2, there is no way for the AS to know whether the user will stay on the train or leave the train. In this case, even when the mobile IAB node broadcasts some information, the UE fails to determine which cell (mobile IAB node or fixed macro cell) should be reselected finally. For this reason, which cell the UE should reselect finally depends on the radio condition and the frequency priority. Therefore, the mobile IAB node needs to return the priority of the serving frequency configured as Observation 1. In other words, the mobile IAB node broadcasts the priority of the serving frequency, for example as is the case with the fixed macro cell layer, or stops broadcasting the HSDN cell indication.
Observation 2: When the UE and the mobile IAB node are stopped, the UE fails to determine whether to reselect the mobile IAB node unless the UE recognizes the intention of the user. In other words, this depends on the radio condition.
Observation 3: As in a typical configuration, the mobile IAB cell in the stationary state recovers the frequency priority or HSDN cell indication used by the mobile IAB cell during migration (in other words, this is similar to Observation 1).

However, in light of the above-described observation results, a drawback of the current mechanism is that the SIB of the mobile IAB node needs to be changed depending on the mobility state. However, this may not be a significant problem to be solved.
Observation 4: A drawback of the current mechanism is that the mobile IAB cell needs to change the SIB depending on the mobility state. In other words, Observation 4 is between Observations 1 and 3.

For the subcase A2, the UE can camp on a stationary macro cell with the same reasoning as in Observation 1. In other words, the UE does not perform intra-frequency measurements when the RSRP/RSRQ from the macro cell is sufficient, nor does the UE perform inter-frequency measurements when the priority of the macro cell frequency is higher than that of the mobile IAB node, or when the mobile IAB node broadcasts the HSDN cell indication (when the UE is not in a high mobility state).

For the subcases B3 and B4, for the same reasons as in Observation 2, cell reselection should depend on the radio condition, and the typical configuration of the mobile IAB node in the stationary state as in Observation 3 is also applicable.

However, the subcases A2, B3, and B4 are actions desirable for the surrounding UEs. The WID specifies that no optimization for targeting the surrounding UEs is performed. For the subcase B3, after getting on the train, the UE enters the subcase B1 or B2, but the initial state of the UE remains in the state of the surrounding UE. Therefore, these subcases are uncovered by the Rel-18.
Mobility of the IAB node and the UE thereof is enhanced, including aspects related to group mobility. No optimization for targeting surrounding UEs is performed.
Observation 5: Optimization of targeting of the surrounding UEs is outside the scope of the WI, but the same configuration as that in Observation 1 and Observation 3 may be applicable.

In summary, the existing cell reselection mechanism, that is, a cell reselection mechanism based on a radio condition and a frequency priority, still functions well. For this reason, no enhancement is required for the UE to execute cell reselection.

The HSDN is valid for the subcase A1.
Proposal 3: The RAN2 should agree that no enhancement is required for the UE to execute cell reselection for the mobile IAB node, in other words, the assumption is recovered that was made in regard to the “1-bit mobile IAB cell type indication” in the last conference.

### RACH-Less Handover for Rel-18 UE

The RAN2#119e has reached the following agreement.

The R2 assumes that there is a possibility that an RACH-less procedure may be considered for an on-board RRC connected UE handed over with the mobile IAB node (this also depends on assumption of UL synchronization).

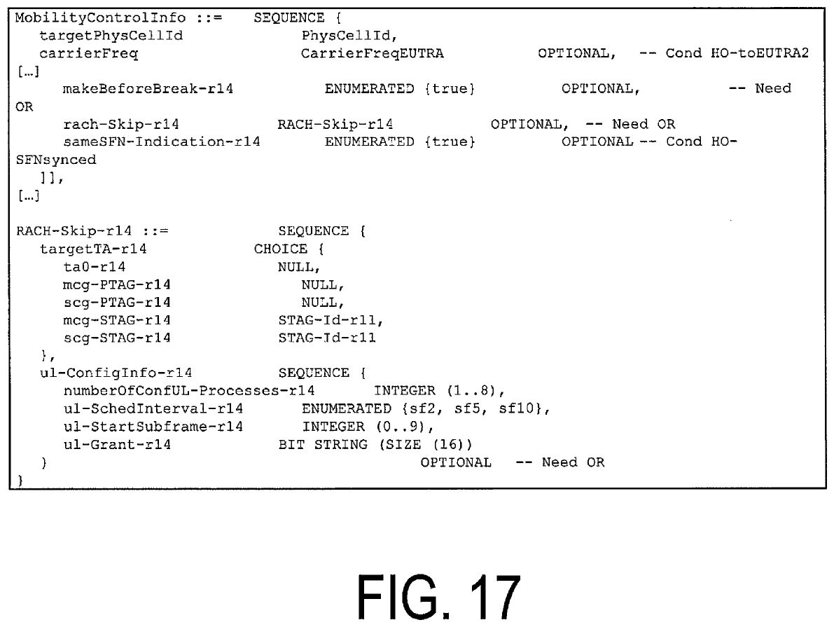

In the LTE, an RACH-less handover is configured as illustrated in FIG. 17 by using applicable timing advance (TA) and uplink grant information in MobilityControlInfo.

Regarding a TA value for the UE in the RACH-less handover during IAB node migration, the source cell and the target cell are provided via the same “physical” DU (however, the source cell and the target cell as provided via two “logical” DUs), and thus the UE is considered to apply the latest TA value in order to access the target cell. In other words, “physical” distances from the UEs should be the same. Accordingly, no explicit TA value needs to be configured for the UE. On the other hand, when an RACH-less handover is used for other scenarios, for example, a mobile IAB-MT handover, a generic approach like the LTE configuration is required.
Proposal 4: The RAN2 should discuss whether the UE should implicitly apply the latest TA value or explicitly configure the corresponding TA value for the RACH-less handover of the UE.

The UE needs to transmit RRC Reconfiguration Complete in UL resources given by the target cell, and thus UL grant information needs to be configured in the UE.
Proposal 5: The RAN2 should agree for the RACH-less handover of the UE that UL grant information is configured by a target IAB donor CU.

Considering an RRC IE structure of NR, an RACH-less configuration can be assumed to be included in reconfigurationWithSync in CellGroupConfig because the RACH-less handover is indicated by the target IAB donor CU during a handover procedure.
Proposal 6: The RAN2 should agree that the RACH-less handover is configured with a handover command (reconfiguration with synchronization).

One question is whether the RACH-less handover is also applicable to a conditional handover. The RAN2#119e agreed that it would be useful to support a conditional RACH-less handover because “R2 assumes that a CHO or a delayed RRC configuration can be the baseline for group mobility”.
Proposal 7: The RAN2 should discuss whether the RACH-less handover can also be configured with a conditional handover (conditional reconfiguration).

### Enhancement of IAB-MT Mobility

### Indication of the Mobile IAB Node to the IAB Donor CU

In the RAN3#117e, the following agreement was made.

The donor CU should know that the IAB node is “mobile”.

The RAN2#119bis-e has agreed on the following baseline.

UE capability signalling is a baseline for informing the CU that the MT is of the “mobile IAB” type. Early mobile IAB indication in Msg5 or the like requires further studies.

With respect to the mobility state/mode indication, the R2 has seen that legacy reports of the mobility state (such as mobilityState-r16) may be reused and that current location reports from the UE may also be reused. Further studies are required as to whether any of these needs to be enhanced or supplemented, such as for the potential purpose of predictive mobility.

In the Rel-16 IAB, an IAB Node Indication is transmitted via a Msg5, which is intended for use by a donor to select an AMF that supports an IAB. Thus, one of the points is whether to transmit the mobile IAB node indication via the Msg5 depending on whether the donor needs to select the AMF supporting the mobile IAB. This is up to the RAN3.

In discussion on e-mails, a plurality of companies pointed out that the donor CU can acquire a real-time mobility state through the existing measurement report such as Immediate MDT. Such mobility state information is considered to be useful for predictive mobility control. A reporter clarified that the mobile IAB node indication is necessary for the donor to configure the mobile IAB node with appropriate measurement configurations. However, no serious problem is posed when the donor CU configures the mobile IAB node after receiving the UE capability signaling, and thus performing the early indication is not justified.

Therefore, whether the early mobile IAB indication is required is up to the RAN3.
Observation 6: For example, whether the early mobile IAB indication in the Msg5 is required is up to the RAN3 depending on whether the donor CU needs to select the AMF supporting the mobile IAB.

### Access Restriction of Mobile IAB Node

In the WID, mobile IAB nodes provide services only to UEs.
The mobile IAB nodes do not have descendant IAB nodes and provide services only to UEs.

To achieve requirements, the RAN2#119e has agreed as follows.

A method of not broadcasting the “iab-Support” indication is sufficient to prevent other IAB nodes from accessing the mobile IAB (without further influence on the specifications).

However, the agreement was reached without sufficient discussion. In particular, for the portion “(without further influence on the specifications)”, whether the determination of the need may be left to implementation is questionable. The WID clearly requires the mobile IAB node to be prevented from accessing other mobile IAB nodes, and thus the specifications may need to clarify the above-described assumption in order to avoid confusion in mobile IAB implementations. For this reason, the Stage-2 specifications desirably incorporate the agreement or clarify that “in this release, the mobile IAB node cannot access other mobile IAB nodes”.
Proposal 8: The RAN2 should agree to include, in the Stage-2 specifications, not configuring an IAB-Support IE in the SIB when the IAB node operates as a mobile IAB node in the present release.

Another restriction was discussed in the RAN2#119bis-e and determined to be further studied as follows.

Further studies are required for the case of introduction of broadcasting, by a fixed network, of the indication that “mobile IAB is supported” (which is intended for mobile IAB MT).

A plurality of companies have pointed out that “whether an indication from the network to the mobile IAB node is required may depend on whether the mobile IAB node can camp on/connect to a regular IAB-capable cell”. Assuming that a legacy IAB donor is present in the network, three releases of IAB are present and different mobility mechanisms are supported according to the release. In other words, the Rel-16 supports intra-CU topology adaptation, the Rel-17 supports inter-CU topology adaptation with partial migration, and the Rel-18 supports inter-CU movement with full migration.

In other words, technically, a mobile IAB node can connect to a Rel-16 donor when the mobile IAB node only migrates close to the Rel-16 donor (i.e., within a cell belonging to the same donor CU). On the other hand, when migrating away, the mobile IAB node needs to connect to a Rel-17 or Rel-18 donor (i.e. connection between cells belonging to different donor CUs). In other words, the formerly mobile IAB node can be viewed as a stationary IAB node from a functional point of view.
Observation 7: The mobile IAB node can connect to the Rel-16 donor when migrating only slightly, but needs to connect to the Rel-17 or Rel-18 donor when migrating far.

In this sense, some “mobile IAB supported” information broadcast from the parent node is required, but whether the mobile IAB node can determine a connectible cell from only such a 1-bit indication is questionable. For example, the indication may be associated with an area in which the mobile IAB node can migrate. However, the indication may mean that an area to which the mobile IAB node is to migrate needs to be determined (or whether the IAB node is considered stationary. For example, according to OAM configurations). In addition, it is worth studying whether there are other cases where the mobile IAB node is allowed to connect to a parent node that does not broadcast the indication. For example, the mobile IAB node may not find the parent node that broadcasts the indication. Accordingly, the RAN2 should discuss in detail what this indication means.
Proposal 9: The RAN2 should agree to introduce some “mobile IAB supported” indication. Further studies are required as to whether the indication is merely a 1-bit indication or whether there is a condition under which the mobile IAB node is granted access to a parent node that does not broadcast the indication.

1. A communication control method used in a cellular communication system, the communication control method comprising:
broadcasting, by a parent node, migration range support information supporting a migration range of a mobile relay node;
receiving, by the mobile relay node, the migration range support information; and
determining, by the mobile relay node, whether access to the parent node is available based on the migration range support information.

2. The communication control method according to claim 1, wherein
the migration range support information represents either a migration method for the mobile relay node that is supportable by the parent node or a migration range of the mobile relay node that is supportable by the parent node.

3. The communication control method according to claim 2, wherein
the migration method for the mobile relay node is one of intra-CU migration, partial migration, and full migration.

4. The communication control method according to claim 1, further comprising
receiving, by the mobile relay node, migration range information regarding the migration range of the mobile relay node from an operations, administration and management apparatus (OAM) or an access mobility management apparatus (AMF).

5. The communication control method according to claim 4, further comprising
determining, by the mobile relay node, whether the parent node broadcasts mobile relay node support information indicating that the mobile relay node is supported, wherein
the determining whether access to the parent node is available comprises determining, by the mobile relay node, whether access to the parent node is available based on whether the mobile relay node support information is broadcast and the migration range information.

6. A communication control method used in a cellular communication system, the communication control method comprising:
checking, by a mobile relay node, whether a serving cell and neighboring cells broadcast mobile relay node support information indicating that the mobile relay node is supported; and
accessing, by the mobile relay node, a selected cell upon confirming that none of the serving cell and the neighboring cells broadcast the mobile relay node support information.

7. A mobile relay node used in a cellular communication system, the mobile relay node comprising:
a receiver configured to receive from a parent node, migration range support information supporting a migration range of a mobile relay node, and
a controller configured to determine whether access to the parent node is available based on the migration range support information.
